(19) United States
(12) Patent Application Publication
(10) Pub. No.: US 2023/0073667 A1
(43) Pub. Date: Mar. 9, 2023

(54) DENITRATION CATALYST STRUCTURE

(71) Applicant: MITSUBISHI HEAVY INDUSTRIES, LTD., Chiyoda-ku, Tokyo (JP)

(72) Inventors: Takuma Kurai, Chiyoda-ku, Tokyo (JP); Tomoyuki Hayashi, Chiyoda-ku, Tokyo (JP); Yoshinori Nagai, Chiyoda-ku, Tokyo (JP); Shimpei Todaka, Chiyoda-ku, Tokyo (JP); Shohei Akagi, Chiyoda-ku, Tokyo (JP)

(73) Assignee: MITSUBISHI HEAVY INDUSTRIES, LTD., Chiyoda-ku, Tokyo (JP)

(21) Appl. No.: 17/795,616

(22) PCT Filed: Jan. 26, 2021
(86) PCT No.: PCT/JP2021/002561

§ 371 Date: Jul. 27, 2022

(30) Foreign Application Priority Data
Jan. 28, 2020 (JP) 2020-011464

(51) Int. Cl. B01J 21/06; B01D 53/86

(52) U.S. Cl. CPC B01J 21/063; B01D 53/8628; B01D 2255/20707; B01D 2255/20723; B01D 2255/20769; B01D 2255/20776

(57) ABSTRACT

Denitration catalyst unit, comprising two or more platy catalyst elements, wherein the platy catalyst element has an edge located on gas-inflow side, an edge located on gas-outflow side and edges located on either side of the platy catalyst element, the platy catalyst elements are piled so as to align the edges located on gas-inflow side and the edges located on either side of the platy catalyst elements respectively, each of the platy catalyst elements alternately has more than one flat part in the shape of a flat plate and more than one concavo-convex part in the shape of platy convex strips on the upper and lower surfaces, the platy convex strips are parallel to one another and are obliquely disposed at an angle θ of not less than 50° and not more than 85° to an extending direction of the edge located on gas-inflow side of the platy catalyst element so that a ridge of the platy convex strip on the upper surface of one of the platy catalyst elements intersects with a ridge of the platy convex strip on the lower surface of another of the platy catalyst elements adjacent, at least one of the intersection points is within a range x of more than 0 mm and less than 25 mm inward from the edge located on gas-inflow side of the platy catalyst element.

### TECHNICAL FIELD

The present invention relates to a denitration catalyst unit. More specifically, the present invention relates to a denitration catalyst unit that can realize a high denitration ratio with a low pressure loss and contribute to a reduction in initial running cost.

### BACKGROUND ART

In the presence of a denitration catalyst, nitrogen oxides contained in gas discharged from fireplaces of a boiler in thermal power plants or various factories, or fireplaces of garbage incinerators are decomposed to purify the discharged gas. Various denitration catalyst structures or denitration catalyst units have been proposed in order to decompose nitrogen oxides in an exhaust gas with high efficiency.

For example, Patent Document 1 discloses a catalyst structure comprising a plurality of platy catalyst elements stacked in layers, wherein the platy catalyst element comprises a plate and a catalytic component with catalytic activity supported on the surface of the plate, the plate is formed with alternately and repeatedly a flat part and a ridge part at intervals wherein the ridge part is composed of a band-shaped protrusion, characterized in that the ridge parts in each of the catalyst elements are arranged in a direction that partially blocks gas flow continuously or stepwise in gas flow direction.

Patent Document 2 discloses a catalyst structure comprising a plurality of platy catalyst elements stacked in layers, wherein the platy catalyst element comprises a plate and a catalytic component supported on the surface of the plate, the plate is formed with alternately and repeatedly in parallel at intervals a flat part and a ridge part which is composed of a band-shaped protrusion, in arrangement so that the ridge part obstructs a gas flow, characterized in that the ridge parts are alternately adjacent to each other on the front and back of the platy catalyst element, and each has two or more of the band-shaped protrusions with the same quantity, and the platy catalyst elements are arranged so that the ridge part has 0 < θ ≤ 90° with respect to gas flow direction, which are alternately inverted and stacked in order, wherein θ is an inclination angle of the ridge part with respect to the gas flow direction.

Patent Document 3 discloses, as Example 14, that forty-six catalyst base materials are stacked into a catalyst frame to obtain a catalyst carrier unit having a size of 150 mm x 150 mm x 250 mm, wherein the catalyst base material has a size of 150 mm x 250 mm and has six waveform lines having a height of 2 mm at an oblique angle (about 30°) with respect to the long side and an interval of 30 mm on the short side, and the unit is immersed in a catalyst slurry, which are dried and fired to obtain a unit-shaped catalyst.

### Citation List

### Patent Literatures.

PATENT DOCUMENT 1 : WO 96/014920 A1

PATENT DOCUMENT 2 : JP 2000-117120 A

PATENT DOCUMENT 3 : JP 2002-361092 A

### SUMMARY OF THE INVENTION

### Problems to Be Resolved by the Invention

In the catalyst structure in the prior art, as shown in FIG. 12, when the platy catalyst element is pooped out by heat during operation, the edge part on the gas inflow side of the platy catalyst element bends, as such the width d of the flow path may be narrowed or uneven, resulting in an increase in pressure loss and a decrease in the denitration ratio.

An object of the present invention is to provide a denitration catalyst unit capable of achieving a high denitration ratio with a low pressure loss and contributing to a reduction in initial running costs such as fan power.

### Means for Solving the Problems

As a result of studies for solving the above problems, the present invention including the following aspects has been completed.

[1] A denitration catalyst unit, comprising two or more platy catalyst elements, wherein the platy catalyst element has an edge located on gas-inflow side, an edge located on gas-outflow side and edges located on either side of the platy catalyst element, the platy catalyst elements are piled so as to align the edges located on gas-inflow side and the edges located on either side of the platy catalyst elements respectively, each of the platy catalyst elements alternately has more than one flat part in the shape of a flat plate and more than one concavo-convex part in the shape of platy convex strips on the upper and lower surfaces, the platy convex strips are parallel to one another and are obliquely disposed at an angle θ of not less than 50° and not more than 85° to an extending direction of the edge located on gas-inflow side of the platy catalyst element so that a ridge of the platy convex strip on the upper surface of one of the platy catalyst elements intersects with a ridge of the platy convex strip on the lower surface of another of the platy catalyst elements adjacent, at least one of the intersection points is within a range x of more than 0 mm and less than 25 mm inward from the edge located on gas-inflow side of the platy catalyst element.

[2] The denitration catalyst unit according to [1], wherein each of the platy catalyst elements comprises a platy base material and a catalytic component supported on the platy base material.

[3] A platy catalyst element having an edge located on gas-inflow side, an edge located on gas-outflow side and edges located on either side of the platy catalyst element, wherein the platy catalyst element alternately has more than one flat part in the shape of a flat plate and more than one concavo-convex part in the shape of platy convex strips on the upper and lower surfaces, the platy convex strips are parallel to one another and are obliquely disposed at an angle θ of not less than 50° and not more than 85° to an extending direction of the edge located on gas-inflow side of the platy catalyst element, when and if the platy catalyst elements are piled so as to align the edges located on gas-inflow side and the edges located on either side of the platy catalyst elements respectively, so that a ridge of the platy convex strip on the upper surface of one of the platy catalyst elements intersects with a ridge of the platy convex strip on the lower surface of another of the platy catalyst elements adjacent, at least one of the intersection points is within a range x of more than 0 mm and less than 25 mm inward from the edge located on gas-inflow side of the platy catalyst element.

[4] The platy catalyst element according to [3], comprising a platy base material and a catalytic component supported on the platy base material.

### Advantageous Effects of the Invention

The present invention can realize a high denitration ratio with a low pressure loss and contribute to a reduction in initial running cost. The present invention is suitable for removing nitrogen oxides (NOx) contained in the exhaust gas of a gas-fired plant.

### BRIEF DESCRIPTION OF THE DRAWINGS

FIG. 1 is a three-sided view (front surface, upper surface, right side surface) showing the platy catalyst element A used in the present invention.

FIG. 2 is a three-sided view (front surface, upper surface, right side surface) showing the platy catalyst element B used in the present invention.

FIG. 3 is a front view showing an example of the denitration catalyst unit of the present invention.

FIG. 4 is an oblique view showing an example of the denitration catalyst unit of the present invention.

FIG. 5 is a top perspective view showing the arrangement of intersection points of the ridge of the platy convex strip on the upper surface of the platy catalyst element A and the ridge of the platy convex strip on the lower surface of the platy catalyst element B.

FIG. 6 is a top perspective view showing the arrangement of intersection points of the ridge of the platy convex strip on the lower surface of the platy catalyst element A and the ridge of the platy convex strip on the upper surface of the platy catalyst element B.

FIG. 7 is a three-sided view (front surface, upper surface, right side surface) showing the platy catalyst element C used in the present invention.

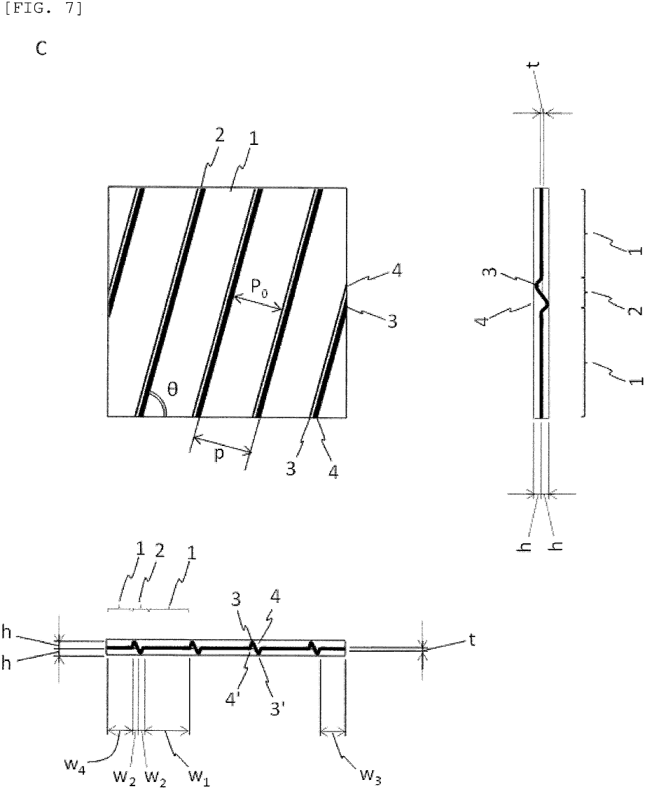

FIG. 8 is a front view showing an example of the denitration catalyst unit of the present invention.

FIG. 9 is a top perspective view showing the arrangement of intersection points of the ridge of the platy convex strip on the upper surface of the platy catalyst element A and the ridge of the platy convex strip on the lower surface of the platy catalyst element C.

FIG. 10 is a top perspective view showing the arrangement of intersection points of the ridge of the platy convex strip on the lower surface of the platy catalyst element A and the ridge of the platy convex strip on the upper surface of the platy catalyst element C.

FIG. 11 is a diagram showing an example of the state of the edge on the gas inflow side in the denitration catalyst unit of the present invention.

FIG. 12 is a diagram showing an example of the state of the edge on the gas inflow side in the denitration catalyst unit of the prior art.

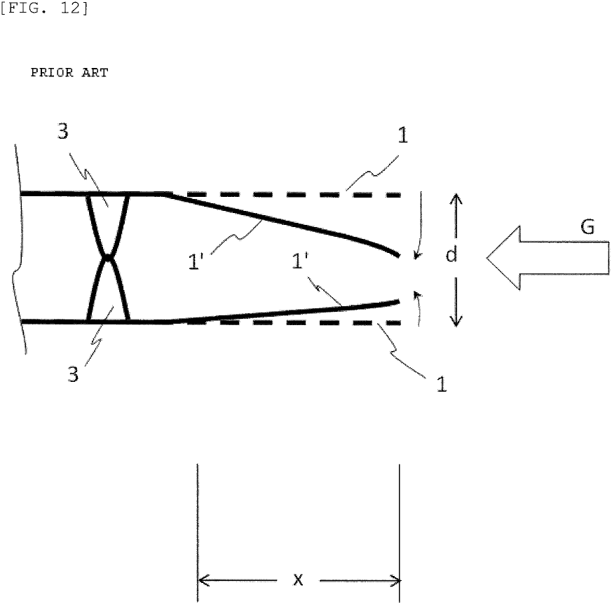

### EMBODIMENTS FOR CARRYING OUT THE INVENTION

Embodiments of the present invention will be specifically described with reference to the drawings. The scope of the present invention is not limited by the following embodiments.

The denitration catalyst unit of the present invention comprises a plurality of platy catalyst elements.

Each of the platy catalyst elements preferably comprises a platy base material and a catalytic component supported on the surface of the platy base material. The platy catalyst element can be obtained, for example, by impregnating and coating a platy base material such as a metal lath, or an inorganic fiber woven fabric or non-woven fabric with a catalytic component to support the catalytic component, and then performing a press working or the like.

The catalytic component is not particularly limited as long as it has a denitration catalytic effect. For example, as the catalytic component, mentioned can be titanium-based catalysts comprising an oxide of titanium, an oxide of molybdenum and / or tungsten, and an oxide of vanadium; zeolite-based catalysts mainly comprising an aluminosilicate such as a zeolite carrying a metal such as Cu or Fe; those comprising a mixture of the titanium-based catalyst and the zeolite-based catalyst. Of these, the titanium-based catalyst is preferable.

Examples of the titanium-based catalysts can include Ti-V-W catalysts, Ti-V-Mo catalysts, Ti-V-W-Mo catalysts and the like.

A ratio of the V element to the Ti element is preferably not more than 2% by weight, more preferably not more than 1% by weight, in terms of a weight percentage of V₂O₅ / TiO₂. A ratio of the Mo element and / or the W element to the Ti element is preferably not more than 10% by weight, more preferably not more than 5% by weight, in terms of a weight percentage of (MoO₃ + WO₃) / TiO₂ when the oxide of molybdenum and the oxide of tungsten are used in combination.

In the preparation of the titanium-based catalysts, titanium oxide powder or titanium oxide precursor can be used as a raw material for the oxide of titanium. Examples of the titanium oxide precursor can include titanium oxide slurry, titanium oxide sol; titanium sulfate, titanium tetrachloride, titanate, titanium alkoxide and the like. In the present invention, as a raw material for the oxide of titanium, those forming anatase-type titanium oxide are preferably used.

As a raw material for the oxide of vanadium, a vanadium compound such as vanadium pentoxide, ammonium metavanadate, or vanadyl sulfate can be used.

As a raw material for the oxide of tungsten, ammonium paratungstate, ammonium metatungstate, tungsten trioxide, tungsten chloride, or the like can be used.

As a raw material for the oxide of molybdenum, ammonium molybdate, molybdenum trioxide, or the like can be used.

The catalytic component used in the present invention can comprise co-catalysts or additives such as an oxide of P, an oxide of S, an oxide of Al (for example, alumina), an oxide of Si (for example, glass fiber), an oxide of Zr (for example, zirconia), gypsum (for example, dihydrate gypsum, etc.), or zeolites. These can be used in the form of powders, sol, slurries, fibers or the like, in the catalyst preparation.

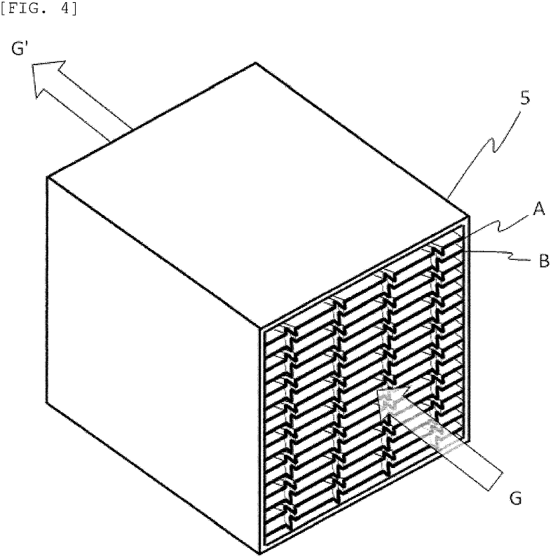

The denitration catalyst unit of the present invention preferably comprises a plurality of platy catalyst elements housed in the frame body 5, as shown in FIG. 4.

Each of the platy catalyst elements has a plate-like shape having an edge located on gas-inflow side, an edge located on gas-outflow side and edges located on either side of the platy catalyst element. The individual plate-like catalyst elements are preferably square or rectangular in overall shape. Then, in the denitration catalyst unit of the present invention, the platy catalyst elements are stacked with the edges on the gas inflow side and the edges located on either side aligned.

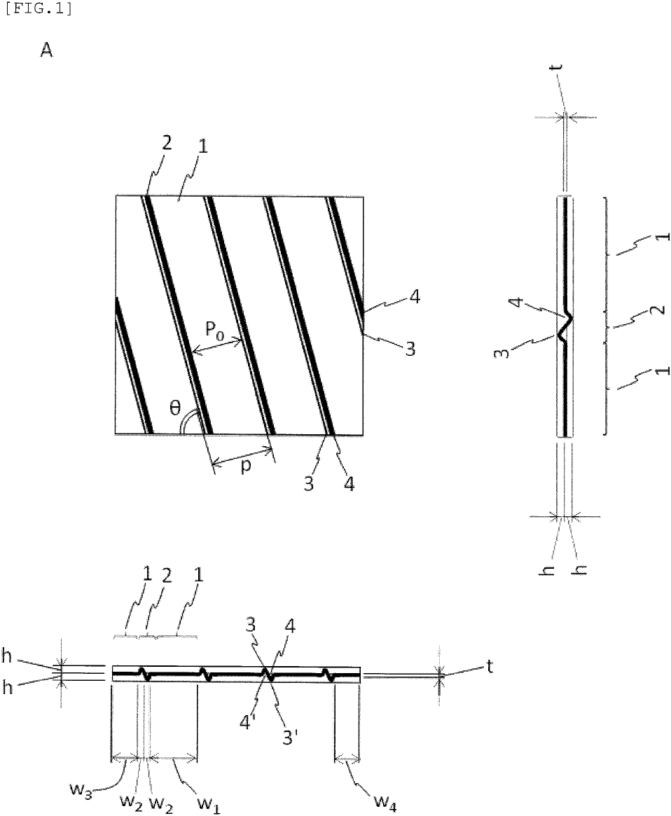

Each of the platy catalyst elements has a plurality of flat parts 1 and a plurality of concavo-convex parts 2 alternately. The flat part 1 has a flat plate shape. The concavo-convex part 2 has a plate shape having convex strip 3 on the upper surface and convex strip 3' on the lower surface in parallel. The convex strips 3, 3' may be curved, but it is preferable that the convex strips 3, 3' are substantially straight as shown in FIG. 1 and the others. The height h of the convex strips 3, 3' and the width w of the convex strips 3, 3' can be appropriately set. The width of the concavo-convex part 2 is 2 w. The width W₂ of the convex strip cross section at the edge on the gas inflow side or the gas outflow side is w / (sin (90° -θ)). It is preferable that the backs of the individual convex strips 3', 3 form concave strips 4, 4' corresponding to the shape of the convex strips 3', 3. It is preferable that each concavo-convex part has a Z-shaped or S-shaped cross section due to the convex strips on the upper surface and the convex strips on the lower surface. In the concavo-convex part 2 shown in the drawings, a thin line indicates a ridge line of a convex strip, and a thick line indicates a valley line of a concave strip. Further, the larger the ratio h / w of the height h to the width w, the higher the denitration ratio tends to be, and the smaller the ratio h / w of the height h to the width w, the lower the pressure loss tends to be. The plate thickness t in the flat part and the concavo-convex part is not particularly limited, but is preferably 0.1 to 0.5 mm.

Each of the convex strips is arranged parallel to each other and obliquely at an angle θ with respect to the extending direction of the edge located on the gas inflow side of the platy catalyst element. The lower limit of the angle θ is 50°, preferably 55°, more preferably 65°, and still more preferably 70°, and the upper limit of the angle θ is 85°, preferably 83°, and more preferably 80°. When the angle θ is small, the effect of increasing the denitration ratio tends to be high. When the angle θ is large, the effect of reducing the pressure loss tends to be high. The parallel convex strips on the same surface are preferably evenly spaced. The distance p between the ridge lines of the parallel convex strips on the same surface can be set as appropriate. The width p₀ is p-2w or w₁ sin(90° - θ). In the platy catalyst element of the present invention, the pressure loss tends to decrease as the angle θ increases, and the denitration ratio tends to increase as the width p₀ decreases.

In the denitration catalyst unit of the present invention, the platy catalyst elements are arranged so that the ridge line of the convex strip 3 on the upper surface of one platy catalyst element intersects and touches with the ridge line of the convex strip 3' on the lower surface of adjacent platy catalyst element. The minor angle θ₁ formed by the two convex strips at the intersection is preferably not less than 10° and not more than 80°, more preferably not less than 20° and not more than 70°, and further preferably not less than 20° and not more than 65°. By arranging the platy catalyst elements so that the ridge lines of the convex strips intersect and touch each other, the lower limit of the average distance between the upper surface of the flat part of the platy catalyst element and the lower surface of the flat part of the adjacent platy catalyst element is regulated by the height of the above-mentioned convex strips 3, 3' .

In the denitration catalyst unit of the present invention, there is at least one of the intersection points 6, 6' in the range x of more than 0 mm and less than 25 mm, preferably not less than 4 mm and not more than 20 mm, more preferably not less than 7 mm and not more than 16 mm, from the edge on the gas inflow side of the platy catalyst element toward the inside (the gas outflow side of the platy catalyst element).

Examples of embodiment in which the intersection points 6 and 6' are located in the range x are shown below.

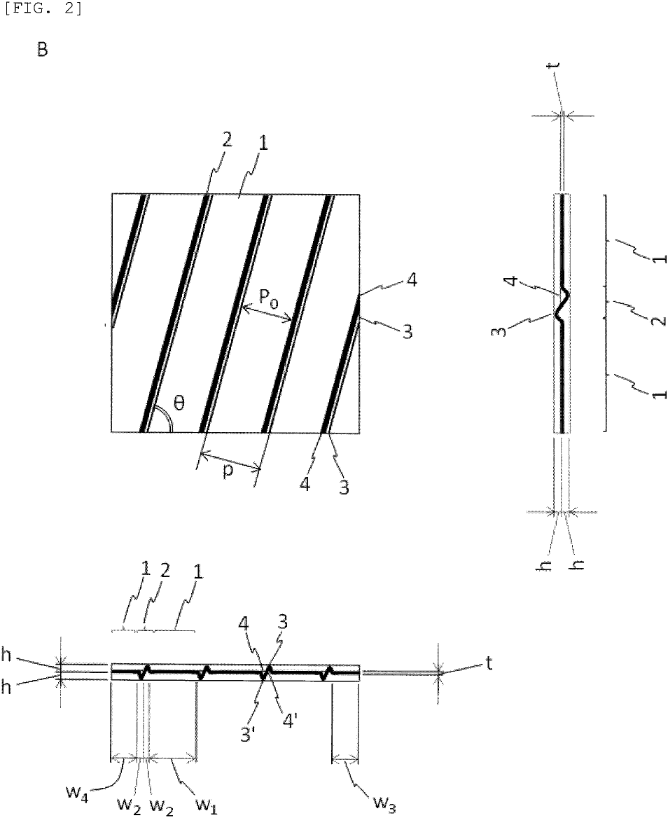

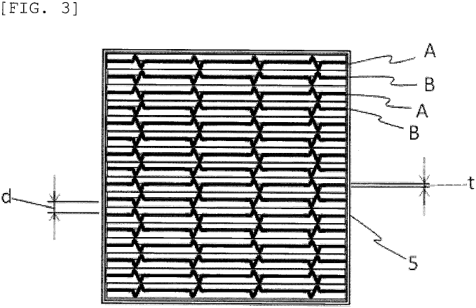

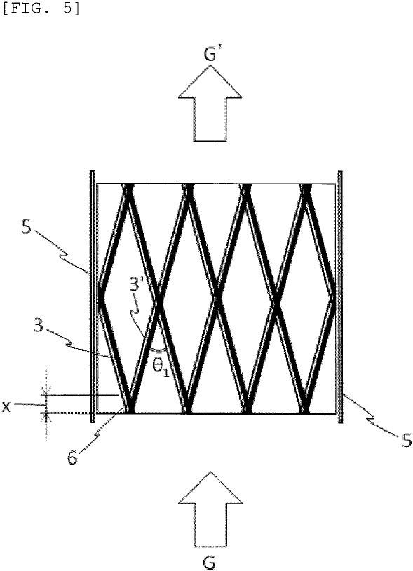

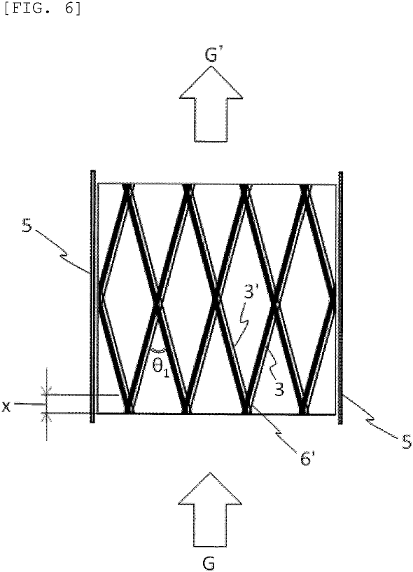

The platy catalyst element B shown in FIG. 2 is one in which the direction of the front and back of the platy catalyst element A shown in FIG. 1 are changed and turned inside out. When turned over in this way, the cross section of the concavo-convex part at the edge located on the front surface (gas inflow) side of the platy catalyst element A forms a Z-shaped waveform, and the cross section of the concavo-convex part located at the edge on the front surface (gas inflow) side of the platy catalyst element B forms an inverted Z-shaped waveform. As shown in FIGS. 3, 5 and 6, the point 6 (FIG. 5) where the ridge line of the convex strip on the upper surface of the platy catalyst element A intersects with the ridge line of the convex strip on the lower surface of the platy catalyst element B and the point 6' (FIG. 6) where the ridge line of the convex strip on the lower surface of the platy catalyst element A intersects with the ridge line of the convex strip on the upper surface of the platy catalyst element B are alternately shifted to the left and right at positions at approximately the same distance from the edge located on the gas inflow side. When, like the platy catalyst element A and the platy catalyst element B, one kind of platy catalyst element is used by turning it upside down, the difference between W₃ and W₄ is preferably 2x / (tan θ), in order that at least one intersection point exists in the range x.

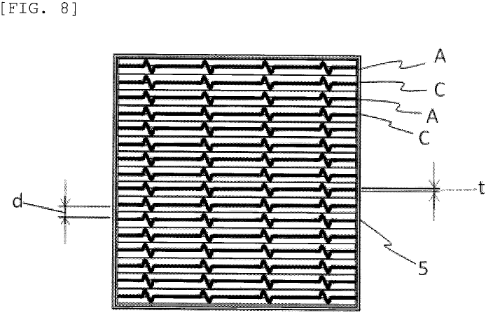

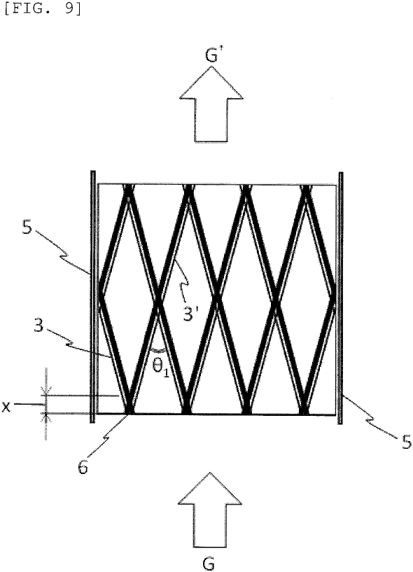

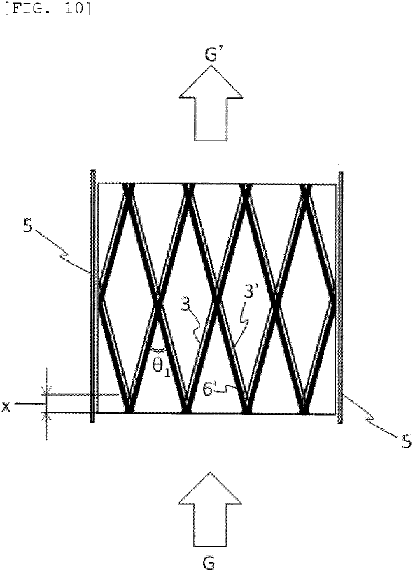

The platy catalyst element C shown in FIG. 6 is one in which a platy catalyst element A shown in FIG. 1 is left and right interchanged and turned inside out. When turned over in this way, both of the cross section of the concavo-convex part on the front surface (gas inflow) side of the platy catalyst element A and the cross section of the concavo-convex part on the front surface (gas inflow) side of the platy catalyst element C form a Z-shaped waveform. As shown in FIGS. 8, 9 and 10, the point 6 where the ridge line of the convex strip on the upper surface of the platy catalyst element A intersects and contacts with the ridge line of the convex strip on the lower surface of the platy catalyst element C and the point 6' where the ridge line of the convex strip on the lower surface of the platy catalyst element A intersects and contacts with the ridge line of the convex strip on the upper surface of the platy catalyst element C are alternately shifted to back and forth at positions at approximately the same distance from the edges on either sides. When, like the platy catalyst element A and the platy catalyst element C, one kind of the platy catalyst element is used by turning it upside down, the difference between W₃ and W₄ is preferably 2x / (tan θ) - 1.5 W₂, assuming that the ridge line of the convex strip is along the midpoint of the width of the convex strip, in order that at least one intersection point exists in the range x.

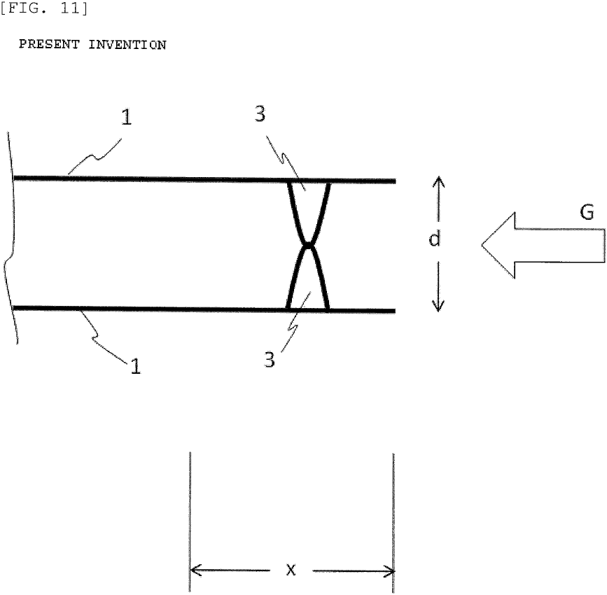

By locating the intersecting points 6 and 6' in the range x, it is possible to prevent the distance d between the upper surface of the flat part of the platy catalyst element and the lower surface of the flat part of the adjacent platy catalyst element at the edge on the gas inflow side from becoming non-uniform (FIG. 11), even when the platy catalyst elements are pooped out and bend. As the result, the denitration catalyst unit of the present invention can realize a high denitration ratio with a low pressure loss, and thus can contribute to a reduction in initial running costs such as fan power.

The effects of the denitration catalyst unit of the present invention will be specifically shown by the following examples.

### Comparative Example

The denitration catalyst unit was assembled by stacking the platy catalyst elements having an angle 9 of 75° and p₀ of 30 mm so that the intersection points 6, 6' were at 30 mm from the edge on the gas inflow side. A simulated combustion exhaust gas was passed through the unit, and the pressure loss and the denitration ratio were measured.

### Examples

The denitration catalyst unit was assembled by stacking the platy catalyst elements A having an angle θ of 75° and p₀ of 30 mm so that the intersection points 6, 6' were at 10 mm from the edge on the gas inflow side as shown in FIGS. 3 to 6. A simulated combustion exhaust gas was passed through the each unit, and the pressure loss and the denitration ratio were measured.

The pressure loss of the denitration catalyst unit of the EXAMPLEs was about 30% lower than the pressure loss of the denitration catalyst units of the COMPARATIVE EXAMPLE. The each denitration ratio of the denitration catalyst units of the EXAMPLEs was higher than the denitration ratio of the denitration catalyst unit of the COMPARATIVE EXAMPLE.

### Code Description

1 : Flat part
2 : Concavo-convex part
3 : Convex strip on the upper surface
4 : Concave strip on the upper surface
3' : Convex strip on the lower surface
4' : Concave strip on the lower surface
5 : Frame body
A : Platy catalyst element
B : Platy catalyst element
6 : The point where the ridge line on the upper surface of the platy catalyst element A and the ridge line on the lower surface of the platy catalyst element B intersect.
6' : The point where the ridge line of the lower surface of the platy catalyst element A and the ridge line of the upper surface of the platy catalyst element B intersect.
G : Inflow gas
G′ : Outflow gas

1. A denitration catalyst unit, comprising two or more platy catalyst elements, wherein the platy catalyst element has an edge located on gas-inflow side, an edge located on gas-outflow side and edges located on either side of the platy catalyst element, the platy catalyst elements are piled so as to align the edges located on gas-inflow side and the edges located on either side of the platy catalyst elements respectively, each of the platy catalyst elements alternately has more than one flat part in the shape of a flat plate and more than one concavo-convex part in the shape of platy convex strips on the upper and lower surfaces, the platy convex strips are parallel to one another and are obliquely disposed at an angle θ of not less than 50° and not more than 85° to an extending direction of the edge located on gas-inflow side of the platy catalyst element so that a ridge of the platy convex strip on the upper surface of one of the platy catalyst elements intersects with a ridge of the platy convex strip on the lower surface of another of the platy catalyst elements adjacent, at least one of the intersection points is within a range x of more than 0 mm and less than 25 mm inward from the edge located on gas-inflow side of the platy catalyst element.

2. The denitration catalyst unit according to claim 1, wherein each of the platy catalyst elements comprises a platy base material and a catalytic component supported on the platy base material.

3. A platy catalyst element having an edge located on gas-inflow side, an edge located on gas-outflow side and edges located on either side of the platy catalyst element, wherein the platy catalyst element alternately has more than one flat part in the shape of a flat plate and more than one concavo-convex part in the shape of platy convex strips on the upper and lower surfaces, the platy convex strips are parallel to one another and are obliquely disposed at an angle θ of not less than 50° and not more than 85° to an extending direction of the edge located on gas-inflow side of the platy catalyst element,
when and if the platy catalyst elements are piled so as to align the edges located on gas-inflow side and the edges located on either side of the platy catalyst elements respectively, so that a ridge of the platy convex strip on the upper surface of one of the platy catalyst elements intersects with a ridge of the platy convex strip on the lower surface of another of the platy catalyst elements adjacent, at least one of the intersection points is within a range x of more than 0 mm and less than 25 mm inward from the edge located on gas-inflow side of the platy catalyst element.

4. The platy catalyst element according to claim 3, comprising a platy base material and a catalytic component supported on the platy base material.
